(19) United States
(12) Patent Application Publication
(10) Pub. No.: US 2010/0180509 A1
(43) Pub. Date: Jul. 22, 2010

(54) In-line access door

(76) Inventors: Clark E. Pridemore, Lancaster, OH (US); Glen A. Edgar, Lancaster, OH (US); Damon R. Hunt, Nampa, ID (US); Rodney L. Carr, Logan, OH (US)

Correspondence Address: Jeffrey Thurnau;Tomkins, IP Law Dept. 10-A3, 1551 Wewatta Street, Denver, CO, 80202, US

(21) Appl. No.: 12/321,544

(22) Filed: Jan. 22, 2009

(51) Int. Cl. E05C 21/00

(52) U.S. Cl. 49/465

(57) ABSTRACT

An in-line access door comprising an inner door for covering and sealing a duct opening, the inner door comprising a hole for receiving a fastener, the fastener engageable with a stud, the stud fixedly attached to the duct, an outer door, a releasable snap fastener for attaching the outer door in a fixed position relative to the duct, an insulating member disposed between the inner door and the outer door, and a gasket disposed between the inner door and the duct for sealing the joint between the inner door and the duct.

### FIELD OF THE INVENTION

The invention relates to an in-line access door, and more particularly, to an in-line access door having an outer door and releaseable fasteners for attaching the outer door in a fixed position relative to the duct.

### BACKGROUND OF THE INVENTION

It often is desirable to have easy access to various different types of ductwork. For example, prior to the installation of the ductwork, it may necessary to install fire system equipment or nozzles and install or reset dampers on the interior of the ductwork. However, once the ductwork has been installed at a site, it may be advantageous to install these access panels after other mechanical and/or electrical equipment has been installed so that areas chosen for the installation of the access panels will least interfere with opening of the access panels and/or will be the best location based on intended use and application.

Additionally, it may be difficult, if not impossible, to access the interior of the ductwork without cutting a hole in the ductwork or otherwise breaching the integrity of the duct wall after the ductwork has been installed. It especially is desirable to be able to access the interior of ductwork used as exhaust ducts so as to be able to remove any buildup on the interior surfaces of the duct wall.

For ductwork used as exhaust or grease ducts serving commercial and institutional kitchens, flammable byproducts, such as grease, may attach to the interior surface of the ducts. This grease buildup often is flammable and grease fires within the exhaust ductwork can be a common occurrence. In order to clean and inspect or to maintain equipment which may possibly be located within the duct, various building and safety codes require a certain number of access ports in the ductwork in order to be able to both clean out the ductwork and to combat any grease fires which may occur in the ductwork.

Access doors are installed at the end of a “snout” extending out from the duct which limits the location in which they can be installed due to the larger amount of space required. Access ports can be created by cutting out a portion of the ductwork or the duct wall so as to allow access to the interior of the duct, and then screwing or otherwise attaching a coverplate over the port. Such access ports often employ numerous fasteners which may require removal and replacement through the use of handtools. However, often such cut-and-cover access ports are not sufficiently well-built so as to survive a fire, that is, are not structurally safe, or to prevent flames and or vapors and gases from escaping from between the cover and the duct wall.

Representative of the art is U.S. Pat. No. 5,165,189 which discloses a An access door assembly for allowing access to the interior of a duct, including a mounting and support frame mounted at a selected location on the duct where an access port previously has been created in the duct, a cover releasably secured to the mounting and support frame by securing means, and a seal interposed between the cover and the mounting and support frame to prevent communication between the interior of the duct and the ambient when the cover is mounted on the frame.

The prior art doors comprise features desirable for relatively permanent attachment when the duct is not otherwise being accessed. This can involve significant time to remove the access door.

What is needed is an in-line access door having an outer door and releaseable fasteners for attaching the outer door in a fixed position relative to the duct. The present invention meets this need.

### SUMMARY OF THE INVENTION

The primary aspect of the invention is to provide an in-line access door having an outer door and releaseable fasteners for attaching the outer door in a fixed position relative to the duct.

Other aspects of the invention will be pointed out or made obvious by the following description of the invention and the accompanying drawings.

The invention comprises an in-line access door comprising an inner door for covering and sealing a duct opening, the inner door comprising a hole for receiving a fastener, the fastener engageable with a stud, the stud fixedly attached to the duct, an outer door, a releasable snap fastener for attaching the outer door in a fixed position relative to the duct, an insulating member disposed between the inner door and the outer door, and a gasket disposed between the inner door and the duct for sealing the joint between the inner door and the duct.

### BRIEF DESCRIPTION OF THE DRAWINGS

The accompanying drawings, which are incorporated in and form a part of the specification, illustrate preferred embodiments of the present invention, and together with a description, serve to explain the principles of the invention.

FIG. 1 is an exploded view of the inner door.

FIG. 2 is a plan view of the inner door.

FIG. 3 is a side view of the inner door.

FIG. 4 is a detail of an inner door fastener.

FIG. 5 is a perspective view of the inner door assembly.

FIG. 6 is an exploded view of the outer door and insulation.

FIG. 7 is a perspective view of the outer door.

FIG. 8 is a cross-sectional view of the door.

### DETAILED DESCRIPTION OF THE PREFERRED EMBODIMENT

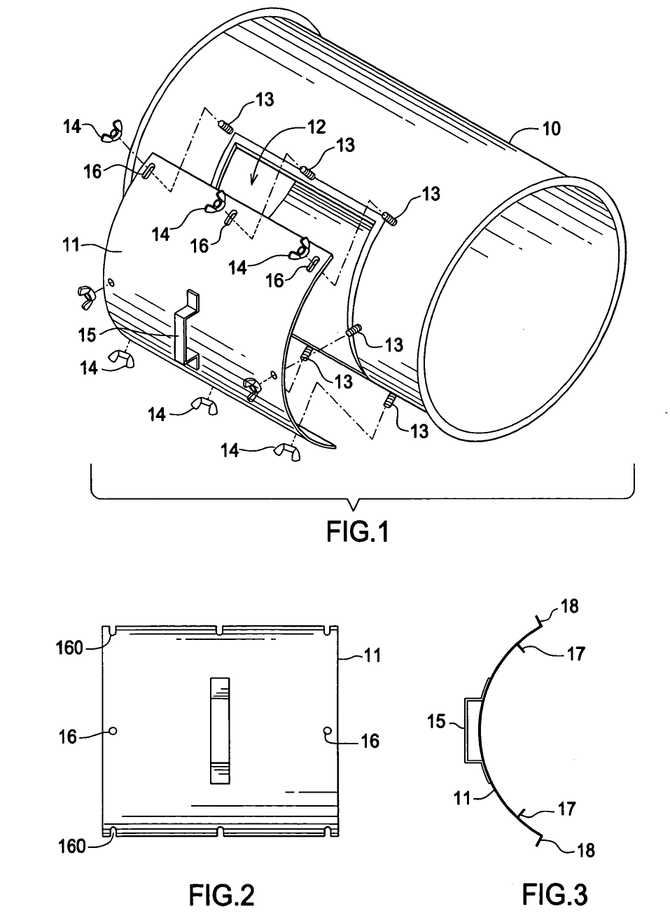

FIG. 1 is an exploded view of the inner door. A typical duct 10 comprises an access opening 12. Duct 10 comprises a flue for high temperature gases such as in a cooling or manufacturing environment.

An inner door 11 covers the opening 12. Fasteners 14 are used to install door 11 over opening 12. Fasteners 14 engage studs 13. Studs 13 are disposed about an outer perimeter of opening 12. Studs 13 engage door 11 through slots or holes 16. One can see that the in-line access door is installed directly on the duct and does not require a “snout” or other connective member by which the access door is attached to the duct.

Handle 15 allows ease of handling door 11.

FIG. 2 is a plan view of the inner door. In an alternate embodiment holes 16 may instead comprise notches 160. Each notch 160 allows ease of installation of the door when the duct 10 is curved or round as shown in FIG. 1.

FIG. 3 is a side view of the inner door. Door 11 may comprise a dam 17 and a reinforcing member 18. Dam 17 engaged the duct opening and serves to prevent escape of gases from the duct 10. Member 18 stiffens the outer edge of the door thereby preventing excessive flexing during installation and use.

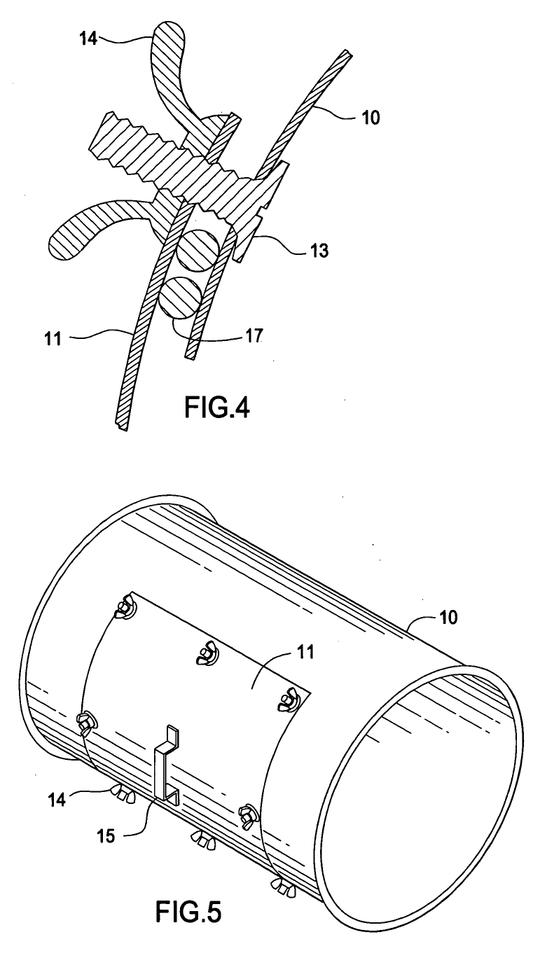

FIG. 4 is a detail of an inner door fastener. Fastener 14 is engaged with stud 13. Gasket 17 seals the door around the opening and prevents escape of flue gas from the duct 10. Gasket 17 may comprise a heat resistant material. Gasket 17 may further comprise a single or double rope of material.

FIG. 5 is a perspective view of the inner door assembly. Inner door 11 is shown installed over opening 12 in duct 10.

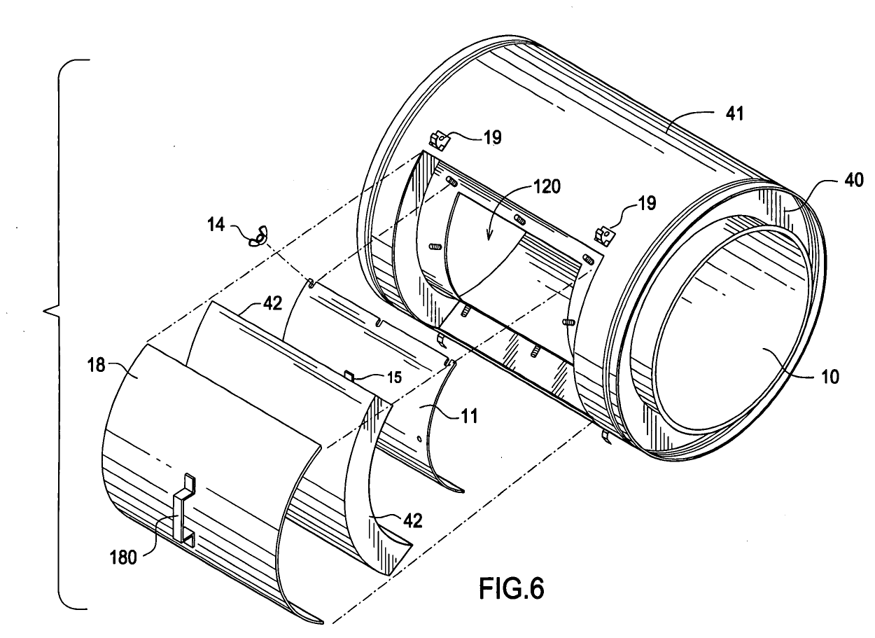

FIG. 6 is an exploded view of the outer door and insulation. Insulation 40 is installed over the outer surface of duct 10 in a manner known in the art. Insulation 40 may comprise fiberglass or mineral wool batting, or calcium silicate or any other suitable insulation known in the art. Metallic lagging 41 is installed over the insulation to protect the insulation and to hold the insulation to the duct 10.

An opening 120 in lagging 41 and insulation 40 allows access to the duct 10.

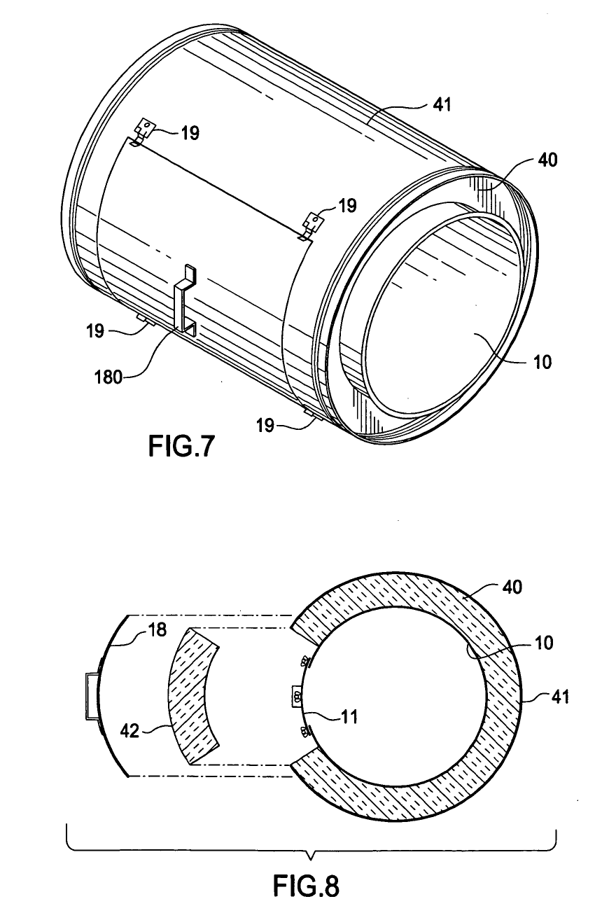

FIG. 7 is a perspective view of the outer door. Snap locks 19 are disposed about the outer edge of opening 120. Snap locks 19 allow quick access to the inner door by simplifying removal of the outer door. The snap locks are easily disengaged from the outer door without use of tools and in a short period of time. The snap locks comprise zinc-plated or stainless steel. For example, but not by way of limitation, in the instant embodiment snap locks 19 comprise snap fastener model number A-1 available from Ludwig Manufacturing Co., 1405 16^{th} Street, Racine, Wis. 53403. http://www.ludwigracinewi.com/productspageone.html. Snap locks 19 retain outer door 18 in place over plug 42 and inner door 11. To reduce heat flow, an insulation plug 42 is disposed between inner door 11 and outer door 18. Plug 42 generally comprises the same insulation material as is applied to the duct 10. Handle 180 is attached to outer door 18.

FIG. 8 is a cross-sectional view of the door. Plug 42 is shaped to accommodate the curved form of the duct. In an alternate embodiment, duct 10 is rectangular and the portion comprising the opening 12 is planar and so the inner and outer doors are planar.

Although a form of the invention has been described herein, it will be obvious to those skilled in the art that variations may be made in the construction and relation of parts without departing from the spirit and scope of the invention described herein.

I claim:

1. An in-line access door comprising:
an inner door (11) for covering and sealing a duct opening (12), the inner door comprising a hole (16) for receiving a fastener (14);
the fastener engageable with a stud (13), the stud fixedly attached to the duct;
an outer door (11);
a releasable snap fastener (19) for attaching the outer door in a fixed position relative to the duct;
an insulating member (42) disposed between the inner door and the outer door; and
a gasket (17) disposed between the inner door and the duct for sealing the joint between the inner door and the duct.

2. The in-line access door as in claim 1, wherein the inner door further comprises a handle.

3. The in-line access door as in claim 1, wherein the fastener comprises a wing nut.

4. The in-line access door as in claim 1, wherein the inner door further comprises a dam for sealing engagement with the duct opening.

5. The in-line access door as in claim 1, wherein the inner door further comprises a reinforcing member.
